(19) United States
(12) Patent Application Publication
(10) Pub. No.: US 2008/0078649 A1
(43) Pub. Date: Apr. 3, 2008

(54) Coin Mechanism

(75) Inventor: Eiki Wakabayashi, Isesaki-shi (JP)

Correspondence Address: BANNER & WITCOFF, LTD., 1100 13th STREET, N.W., SUITE 1200, WASHINGTON, DC, 20005-4051, US

(73) Assignee: SANDEN CORPORATION, Isesaki-shi (JP)

(21) Appl. No.: 11/861,423

(22) Filed: Sep. 26, 2007

(30) Foreign Application Priority Data
Sep. 28, 2006 (JP) 2006-264111

(51) Int. Cl. G06F 9/00

(52) U.S. Cl. 194/216

(57) ABSTRACT

A coin mechanism is provided with a setting input switch and a control device. The control device has a storage section in which setting information necessary for control processing is stored, and a setting change section which changes a value in the setting information stored in the storage section on the basis of the kind of a coin identified by a coin identification device and an input value from the switch.

### Background of the invention

1. Field of the invention

The present invention relates to a coin mechanism used in a vending machine or the like.

2. Description of the related art

As this kind of coin mechanism, one described in Japanese Patent Publication 2001-256536 is known. This coin mechanism is provided with a coin identification device which identifies the kind of a coin put in, coin holder tubes in which coins are held with respect to kinds of coin, a coin distribution device which selectively sets the course of transport of the put-in coin between paths to the coin holder tubes according to the kind of the put-in coin identified by the coin identification device, and a control device which controls the coin identification device and the coin distribution device. This kind of coin mechanism also has switches provided as input means for performing various setting operations, e.g., operations for setting kinds of coin to be held in the coin holder tubes.

With the improvements in functions of coin mechanisms in recent years, e.g., the increase in the number of kinds of coin or currency to be handled and the change in identification accuracy, the number of items of setting in a coin mechanism has increased. To meet this change, a method of providing special-purpose switches corresponding to increased setting items may be used. This method enables intuitive manager's setting operations but entails a problem that the cost of switches is increased and it is difficult to reduce the size of the apparatus. A method of functionally operating switches such as a ten-key cluster and performing a setting operation by means of particular operations of the switches is also conceivable. However, this method requires a manager to have the skills to perform operations with respect to setting items and required complicated operations, so that the possibility of errors in setting is increased.

### BRIEF SUMMARY OF THE INVENTION

An object of the present invention is to provide a coin mechanism capable of executing management operations with efficiency.

To achieve the above-described object, according to the present invention, there is provided a coin mechanism having a coin identification device for determining whether or not a coin put is genuine and for identifying the kind of the coin, a coin distribution device for selectively setting the course of transport of the coin between an acceptance path and a discharge path according to a result of identification by the coin identification device, and a control device for controlling the coin identification device and the coin distribution device, wherein the control device includes a main control section for controlling the coin identification device and the coin distribution device in a normal mode, and a management processing section for performing processing for management in a management mode, and wherein the management processing section performs particular processing according to the kind of coin identified by coin identification means.

According to the present invention, various kinds of processing can be performed in the management mode on the basis of the kind of the coin put in. That is, the method of putting in a coin as a means for inputting a command to the control device facilitates various management operations including changing setting information and commanding to start a particular processing.

In an example of a preferred form of the present invention, the control device further includes storage section for storing setting information necessary for control processing, and the management processing section changes a value in the setting information stored in the storage section according to the kind of coin identified by the coin identification device. According to the present invention, the kind of the coin put in can be used as input data, which facilitates change of setting information. The number of setting items with respect to kinds of coin is particularly large in this kind of coin mechanism. Advantageously, when a change is made in such a large number of setting items, one of the kinds of coin can be designated by putting in the corresponding coin.

In another preferred form of the present invention, the coin mechanism further has mode selection means for selecting between the normal mode and the management mode, and the control device selects, by the mode selection means, between processing by the main control section and processing by the management processing section. In this way, selection can be definitely made between the normal mode and the management mode. The operating system can therefore be clearly defined, which is preferable in terms of prevention of errors in operation.

The above-described coin mechanism may further has a setting input switch, and the management processing section may perform particular processing according to an input value from the switch and the kind of coin identified by the coin identification device. Thus, various kinds of processing are enabled by using an input value from the switch as well as the kind of coin identified by the coin identification device.

In an example of a more concrete form of the present invention, the above-described coin mechanism further has a coin holder in which coins are held with respect to kinds of coin; the coin distribution device selectively sets the course of transport of the coin to a path to the coin holder according to the kind of the coin identified by the coin identification device; and the management processing section makes a setting on the basis of the input value from the switch and the kind of the coin identified by the coin identification device, such that the coin identified by the coin identification device is transported and held in a portion of the coin holder corresponding to the input value from the switch. According to the present invention, the kind of coin to be held in each portion of the coin holder can be set through an intuitive operation.

In another more concrete form of the present invention, the management processing section makes a setting on the basis of the kind of the coin identified by the coin identification device, such that a kind of currency on which processing is to be performed by the main control device is the kind of currency including the identified kind of the coin. According to the present invention, a kind of currency on which processing by the main control device is to be performed can be set through an intuitive operation.

The above-described and other objects, features and effects of the present invention will become apparent from the following detailed description of the invention.

### BRIEF DESCRIPTION OF SEVERAL VIEWS OF THE DRAWINGS

FIG. 1 is a diagram schematically showing the construction of a coin mechanism;

FIG. 2 is a front view of an operation panel;

FIG. 3 is a functional block diagram of a control device;

FIG. 4 is a diagram for explaining an example of setting data stored in a storage section;

FIG. 5 is a flowchart in a case where a distribution setting table is changed;

FIG. 6 is a flowchart in a case where a coin coefficient is changed;

FIG. 7 is a flowchart in a case where a currency to be handled is changed; and

FIG. 8 is a flowchart in a case where the accuracy of identification is changed.

### DETAILED DESCRIPTION OF THE INVENTION

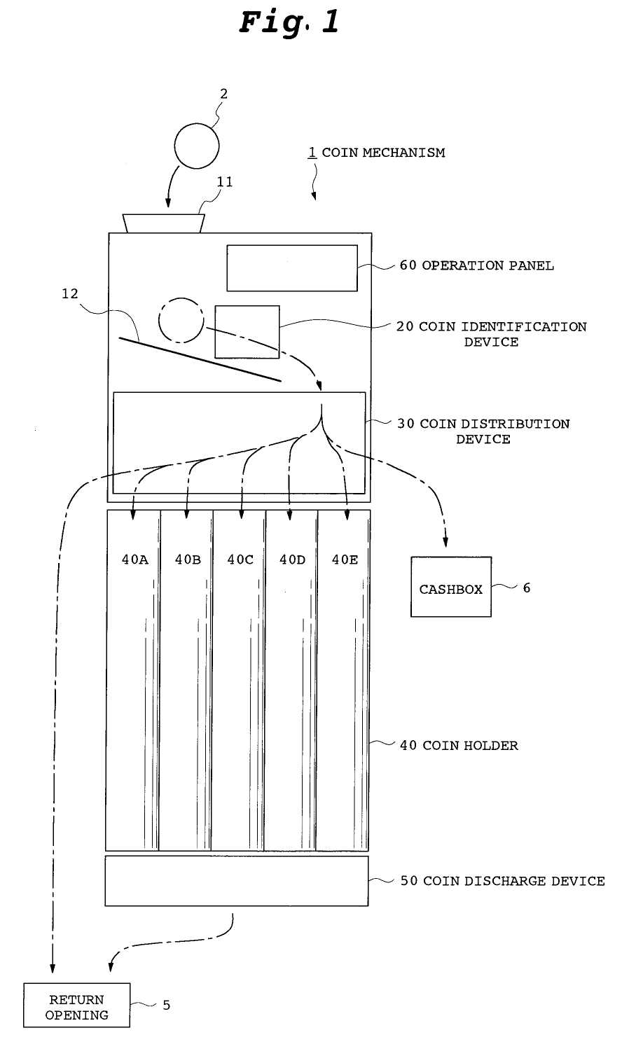

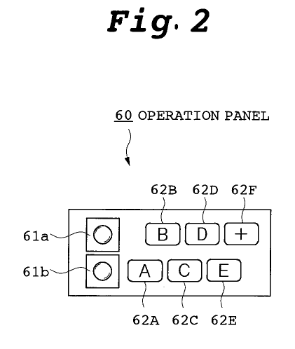

A coin mechanism according to an embodiment of the present invention will be described with reference to the drawings. FIG. 1 is a diagram schematically showing the construction of the coin mechanism. FIG. 2 is a front view of an operation panel.

This coin mechanism 1 is provided with, as shown in FIG. 1, a slot 11 through which a coin 2 is put in, a coin guide path 12 through which the coin 2 put in from the slot 11 is guided, a coin identification device 20 which determines whether or not the coin passing through the coin guide path 12 is genuine and identifies the kind of the coin, a coin distribution device 30 which selectively sets the course of transport of the coin passed through the coin guide path 12 between a removal path and one of acceptance paths provided in correspondence with kinds of coin to be accepted, a coin holder 40 which receive coins distributed by the coin distribution device 30, a coin discharge device 50 which discharges coins received by the coin holder 40, and a control device 100 (not shown in FIG. 1). The slot 11, the coin guide path 12, the coin identification device 20, the coin distribution device 30, the coin holder 40 and the coin discharge device 50 are similar in construction to those in the conventional art. Therefore, no detailed description will be made of these components in this specification.

The coin holder 40 is constituted by a plurality of tubes 40A to 40E formed in correspondence with kinds of coin. The coin distribution device 30 operates according to a command from the control device 100. More specifically, the coin distribution device 30 selectively sets the course of transport of each of coins put in between the paths to the tubes 40A to 40E in the coin holder 40, a predetermined return opening 5 and a cashbox 6.

An operation panel 60 on which display of operating conditions, setting input and other operations are performed is provided in the coin mechanism 1. As shown in FIG. 2, the operation panel 60 has a display portion 61 formed of two LEDs 61a and 61b disposed in upper and lower positions and an input portion 62 formed of six push switches 62A to 62F. In this embodiment, the switches 62a to 62E are provided in correspondence with the tubes 40A to 40E in the coin holder 40 to facilitate setting with respect to each of the tubes 40A to 40E.

The coin mechanism 1 is further provided with a mode selection switch 70 (not shown in FIG. 1) for changing the operating mode between a normal mode and a setting mode. The setting mode is a kind of management mode. In this embodiment, the mode selection switch 70 is formed of a DIP switch having a plurality of contacts. The control device 100 operates in the normal mode when all the contacts of the mode selection switch 70 are off. When one of the contacts is on, the control device 100 operates in the setting mode corresponding to the contact.

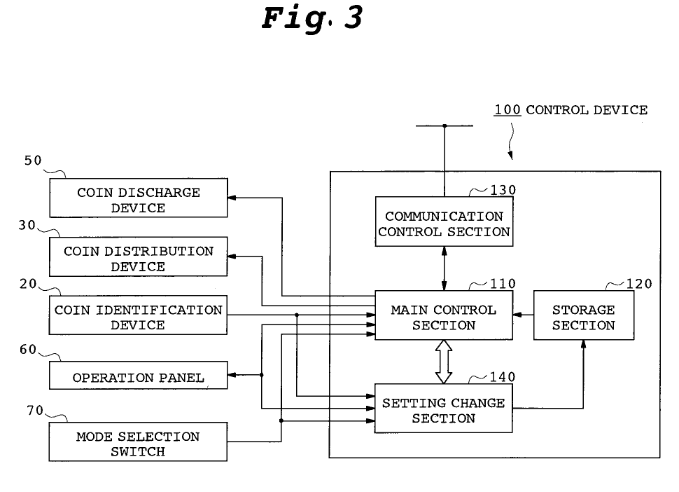

The control device 100 will be described in detail with reference to the functional block diagram of FIG. 3. As shown in FIG. 3, the control device 100 has a main control section 110 which controls each device in the normal mode, a storage section 120 in which various setting items necessary for the operation of the main control section 110 are stored, a communication control section 130 for communication with a device outside the apparatus, and a setting change section 140 for making changes in the various setting items stored in the storage section 120. For example, in a case where the coin mechanism 1 is used in a vending machine, the communication control section 130 is connected to a controller in the vending machine. Selection between the operation by the main control section 110 and the operation by the setting change section 140 is made by means of the above-described mode selection switch 70.

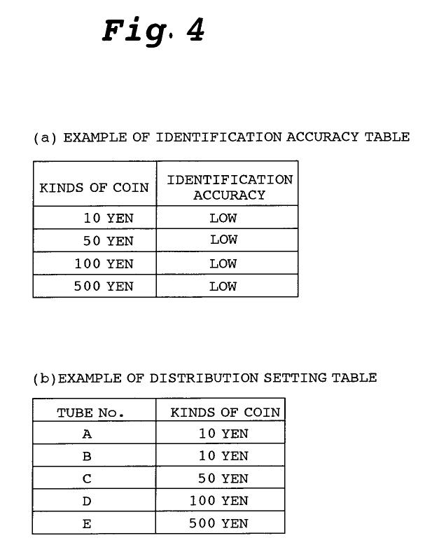

FIGS. 4(a) and 4(b) show an example of the setting items stored in the storage section 120. FIG. 4(a) shows an identification accuracy table in which the accuracy of identification in the coin identification device 20 is set with respect to each kind of coin. FIG. 4(b) shows a distribution setting table in which kinds of coin to be held in the tubes 40A to 40E in the coin holder 40. The main control section 110 determines, by referring to the identification accuracy table, the accuracy of identification in the coin identification device 20 as to whether a put-in coin is genuine. The main control section 110 also determines the correspondence between the kind of the put-in coin and one of the tubes 40A to 40E on the basis of the result of identification by the coin identification device 20 by referring to the distribution setting table, and controls the coin distribution device 30 to hold the put-in coin in the corresponding one of the tubes 40A to 40E. If the put-in coin is a counterfeit as the result of determination by the coin identification device 20, the main control section 110 selects the path for transporting the coin to the return opening 5. If the corresponding one of the tubes 40A to 40E in which the coin is to be held is full, the main control section 110 selects the path for transporting the coin to the cashbox 6. In the storage section 120 is also stored a coin coefficient (not shown in FIG. 4). The coin coefficient represents “the smallest money amount unit at the time of transmission of information on a put-in coin as money amount information to the controller in the vending machine main unit or the like or at the time of reception of a command designating an amount of money to be paid as change from the controller or the like in the vending machine main unit or the like”.

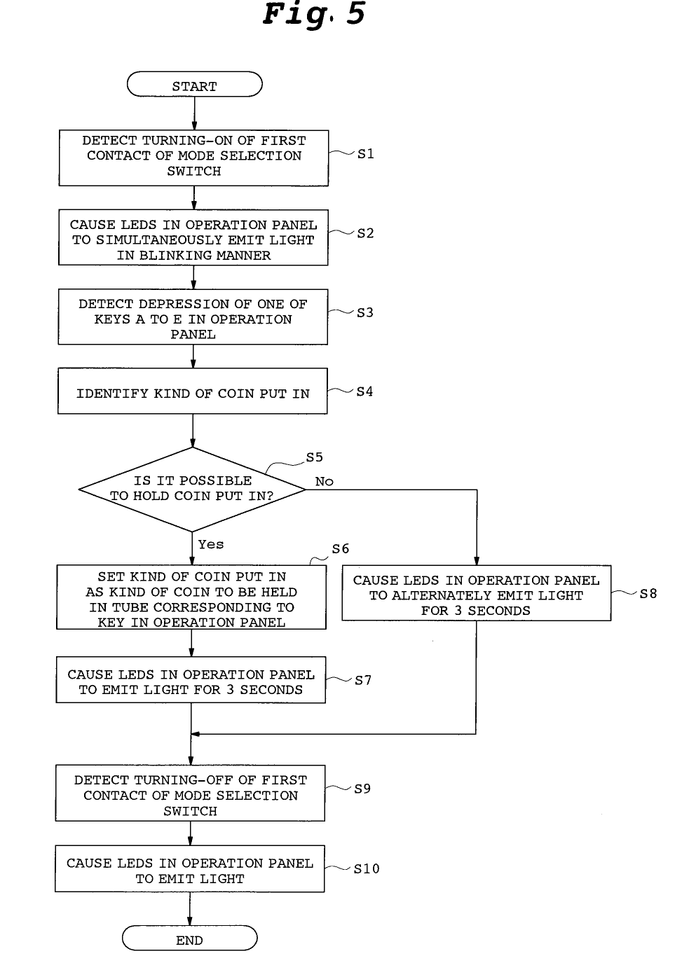

The flow of setting change in the coin mechanism 1 according to the present embodiment will be described with reference to the flowchart of FIG. 5. Description will first be made of a case where part of data in the distribution setting table stored in the storage section 120 is changed. It is assumed that the control device 100 causes both the LEDs 61a and 61b in the display portion 61 to emit light in the normal mode.

When the main control section 110 in the control device 100 detects turning-on of the first contact of the mode selection switch 70 (step S1), it effects a transition of processing to the setting change section 140. The setting change section 140 causes the LEDs 61a and 61b in the display portion 61 to simultaneously emit light in a blinking manner, thereby indicating that the mode change to the setting change mode has been made (step S2). The setting change section 140 then detects a depression of one of the switches 62A to 62E in the operation panel 60 (step S3). When the kind of a coin put in is thereafter identified by the coin identification device 20 (step S4), the setting change section 140 determines whether the coin can be held in one of the tubes 40A to 40E corresponding to the depressed one of the switches 62A to 62E (step S5). The setting change section 140 controls the coin distribution device 30 so that the put-in coin is returned to the return opening 5.

If the setting change section 140 determines that the coin can be held, it updates the distribution setting table in the storage section 120 on the basis of the input value input in the above-described step S3 and the kind of the put-in coin identified in the above-described step S4 (step S6). More specifically, the setting change section 140 sets the kind of the put-in coin identified in the above-described step S4 as the kind of coin to be held in the one of the tubes 40A to 40E corresponding to the one of the switches 62A to 62E through which the input has been given in the above-described step S3. The setting change section 140 thereafter causes the LEDs 61a and 61b in the display portion 61 to emit light for a predetermined time, thereby notifying that the setting change has been completed (step S7). When the setting change section 140 detects turning-off of the first contact of the mode selection switch 70 (step S9), it effects a transition of processing to the main control section 110. The main control section 110 causes the LEDs 61a and 61b in the display portion 61 to emit light, thereby notifying that the transition to the normal mode has been made (step S10).

If the setting change section 140 determines in the above-described step S5 that the coin cannot be held, it causes the LEDs 61a and 61b in the display portion 61 to alternately emit light for a predetermined time period, thereby notifying that the setting change has ended in failure (step S8). When the setting change section 140 thereafter detects turning-off of the first contact of the mode selection switch 70 (step S9), it effects a transition of processing to the main control section 110. The main control section 110 causes the LEDs 61a and 61b in the display portion 61 to emit light, thereby notifying that the transition to the normal mode has been made (step S10).

By the above-described processing, a setting as to which kind of coin is held in each of the tubes 40A to 40E in the coin holder 40 can easily be made. For example, in a case where there is a need to hold a 50-yen coin in the tube 40B, operations to (1) turn on the first contact of the mode selection switch 70, (2) depress the switch 62B corresponding to the tube 40B, (3) put in a 50-yen coin through the slot 11 and (4) return the first contact of the mode selection switch 70 to the off state are performed to complete the setting.

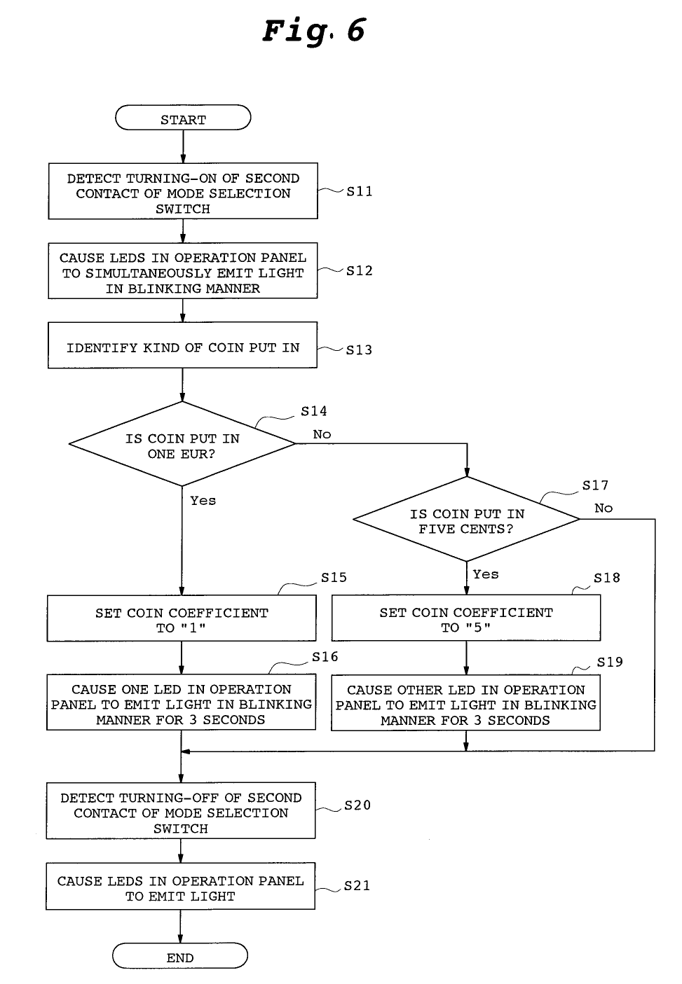

Description with reference to the flow chart of FIG. 6 will next be made of a case where the coin coefficient stored in the storage section 120 is changed. In the present embodiment, particular values are assigned in advance with respect to the kinds of coin and the coin coefficient is updated by the value corresponding to the kind of a coin put in.

When the main control section 110 of the control device 100 detects turning-on of the second contact of the mode selection switch 70 (step S11), it effects a transition of processing to the setting change section 140. The setting change section 140 causes the LEDs 61a and 61b in the display portion 61 to simultaneously emit light in a blinking manner, thereby indicating that the mode change to the setting change mode has been made (step S12). When the kind of a coin put in is thereafter identified by the coin identification device 20 (step S13), the setting change section 140 performs processing corresponding to the kind of the put-in coin. More specifically, if the kind of the put-in coin is one EUR (step S14), the setting change section 140 sets the coin coefficient in the storage section 120 to “1” (step S15) and causes only one LED 61a to emit light in a blinking manner for a predetermined time period to notify that the coin coefficient has been set to “1” (step S16). If the kind of the put-in coin is five cents (step S17), the setting change section 140 sets the coin coefficient in the storage section 120 to “5” (step S18) and causes only the other LED 61b to emit light in a blinking manner for a predetermined time period to notify that the coin coefficient has been set to “5” (step S19). The setting change section 140 controls the coin distribution device 30 so that the put-in coin is returned to the return opening 5.

When the setting change section 140 detects turning-off of the second contact of the mode selection switch 70 (step S20), it effects a transition of processing to the main control section 110. The main control section 110 causes the LEDs 61a and 61b in the display portion 61 to emit light, thereby notifying that the transition to the normal mode has been made (step S21).

By the above-described processing, the coin coefficient stored in the storage section 120 can easily be changed. For example, in a case where there is a need to set the coin coefficient to “5”, operations to (1) turn on the second contact of the mode selection switch 70, (2) put in a 5-cent coin through the slot 11 and (3) return the second contact of the mode selection switch 70 to the off state are performed to complete the setting.

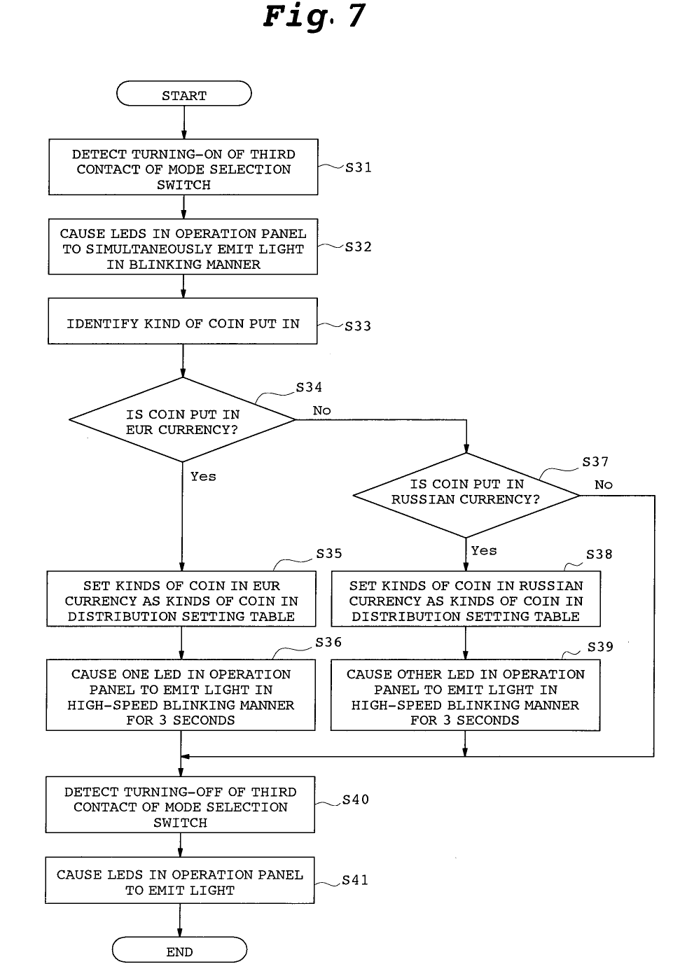

Description with reference to the flowchart of FIG. 7 will next be made of a case where a kind of currency handled by the coin mechanism 1 is changed to a different kind of currency. In this case, the coin data items in the distribution setting table stored in the storage section 120 may be replaced with coin data items for the different kind of currency at a time.

When the control section 110 of the control device 100 detects turning-on of the third contact of the mode selection switch 70 (step S31), it effects a transition of processing to the setting change section 140. The setting change section 140 causes the LEDs 61a and 61b in the display portion 61 to simultaneously emit light in a blinking manner, thereby indicating that the mode change to the setting change mode has been made (step S32). When the kind of a coin put in is thereafter identified by the coin identification device 20 (step S33), the setting change section 140 performs processing corresponding to the currency represented by the put-in coin. More specifically, if the kind of the put-in coin is one of EUR coins (step S34), the setting change section 140 sets the kinds of coins in EUR currency as the kinds of coin in the distribution setting table in the storage section 120 at a time (step S35). The setting change section 140 then causes only one LED 6la to emit light in a high-speed blinking manner for a predetermined time period to notify that a EUR current compatible mode has been set (step S36). If the kind of the put-in coin is one of Russian coins (step S37), the setting change section 140 sets the kinds of coins in Russian (Ruble) currency as the kinds of coin in the distribution setting table in the storage section 120 at a time (step S38). The setting change section 140 then causes only the other LED 61b to emit light in a high-speed blinking manner for a predetermined time period to notify that a Russian current compatible mode has been set (step S39). The setting change section 140 controls the coin distribution device 30 so that the put-in coin is returned to the return opening 5.

When the setting change section 140 detects turning-off of the third contact of the mode selection switch 70 (S40), it effects a transition of processing to the main control section 110. The main control section 110 causes the LEDs 61a and 61b in the display portion 61 to simultaneously emit light, thereby notifying that the transition to the normal mode has been made (step S41).

By the above-described processing, the kinds of coin in the distribution setting table stored in the storage section 120 are set to the kinds of coin in a different kind of at a time. Thus, the currency which can be handled by the coin mechanism 1 can be easily changed. For example, in a case where there is a need to set the EUR coin compatible mode, operations to (1) turn on the third contact of the mode selection switch 70, (2) put in a EUR coin such as 1 EUR coin or 2 EUR coin through the slot 11 and (3) return the third contact of the mode selection switch 70 to the off state are performed to complete the setting.

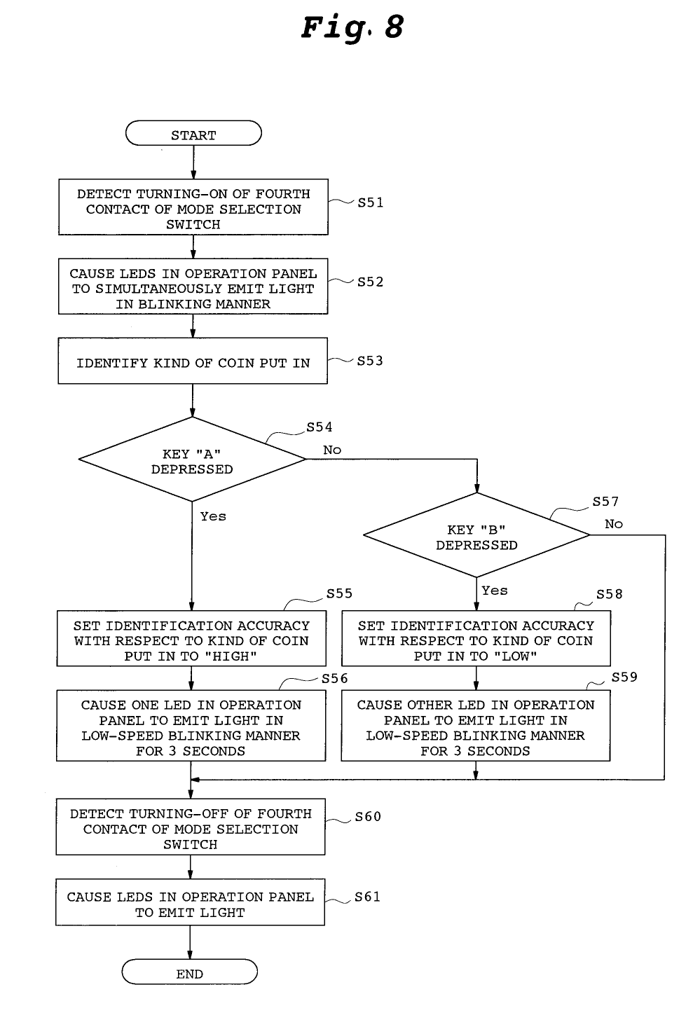

Description with reference to the flowchart of FIG. 8 will next be made of a case where the identification table stored in storage section 120 is changed.

When the main control section 110 in the control device 100 detects turning-on of the fourth contact of the mode selection switch 70 (step S51), it effects a transition of processing to the setting change section 140. The setting change section 140 causes the LEDs 61a and 61b in the display portion 61 to simultaneously emit light in a blinking manner, thereby indicating that the mode change to the setting change mode has been made (step S52). The setting change section 140 identifies the kind of a coin put in by means of the coin identification device 20 (step S53). When the setting change section 140 detects a depression of the switch 62A in the operation panel 60 (step S54) after the coin has been put in, it sets the identification accuracy to “high” with respect to the kind of coin detected in step S53 (step S55) and causes only one LED 61a to emit light in a low-speed blinking manner for a predetermined time period to notify that the identification accuracy has been set to “high” (step S56). When the setting change section 140 detects a depression of the switch 62B in the operation panel 60 after the coin has been put in (step S57), it sets the identification accuracy to “low” with respect to the kind of coin detected in step S53 (step S58) and causes only the other LED 61b to emit light in a low-speed blinking manner for a predetermined time period to notify that the identification accuracy has been set to “low” (step S56). The setting change section 140 controls the coin distribution device 30 so that the put-in coin is returned to the return opening 5.

When the setting change section 140 detects turning-off of the fourth contact of the mode selection switch 70 (step S60), it effects a transition of processing to the main control section 110. The main control section 110 causes the LEDs 61a and 61b in the display portion 61 to emit light, thereby notifying that the transition to the normal mode has been made (step S61).

By the above-described processing, the setting of the identification accuracy with respect to the kinds of coin can easily be changed. For example, in a case where there is a need to set the identification accuracy with respect to 500-yen coins to “high”, operations to (1) turn on the fourth contact of the mode selection switch 70, (2) put in a 500-yen coin through the slot 11, (3) depress the switch 62A in the operation panel 60 and (4) return the fourth contact of the mode selection switch 70 to the off state are performed to complete the setting.

The coin mechanism 1 according to the embodiment uses the method of putting in an actual coin as a method of inputting, for example, a value for a kind of coin or a kind of currency at the time changing one of the various setting items and is, therefore, capable of easily and reliably performing the changing operation. In particular, in a case where a value relating directly to a kind of coin is input as a setting item or a value relating to a kind of currency is input, input of a corresponding coin may suffice. Thus, an intuitive and reliable operation can be performed. If predetermined values (including numeric values, characters, and symbols or the like) are assigned in advance with respect to coins to be put in, even various setting items not relating to the kinds of coin or currency can be changed as desired.

The present invention has been described in detail with respect to one embodiment thereof. However, the present invention is not limited to the described embodiment. While in the above description of the embodiment distribution setting with respect to the kinds of coin, currency compatible mode setting and coin coefficient setting has been described as an example of setting items, the present invention can also be applied to other setting items, e.g., an item of setting as to whether or not whether or not a particular coin is accepted, an item of setting for refusal of acceptance of a predetermined medal called a token, and an item of setting as to whether or not a coin put in is temporarily held in the coin distribution device 30.

While in the above description of the embodiment an example of the setting operation for changing each setting item has been described as an operation in the management mode, information on the kinds of coins put in can also be utilized for other kinds of processing. For example, this kind of coin mechanism ordinarily has a processing function for collecting coins held in the coin holder 40, and a method of putting in a coin as a command to start this processing function may be used. That is, a coin putting in operation may be used as a trigger for starting a particular processing.

While the embodiment has been described by way of example with respect to a case where only one coin is put in, the arrangement may alternatively be such that a plurality of coins lay be successively put in. In such a case, settings corresponding to the kinds of coins successively put in may be made at a time, or one value to be set may be input by means of a plurality of coins. For example, the latter setting method may be such that a numeric value “5” is assigned to 50-yen coins, a numeric value “1” is assigned to 10-yen coins, and a numeric value “6” is used as a value to be set when a 50-yen coin and a 10-yen coin are put in.

While the mode selection switch 70 for selection between the normal mode and the setting change mode which is a kind of management mode and the switches 62A to 62F for setting change input are provided in the above-described embodiment, the two switches may be combined into a common one. Selection between the normal mode and the management mode may be made by putting in a particular coin instead of using the mode selection switch 70.

While the embodiment has been described with respect to the type of coin mechanism provided with the coin holder 40 and the coin distribution device 30 arranged to perform an operation to check the genuineness of each coin put in and an operation to distribute coins with respect to the kinds of coin, the present invention can also be applied to other types of coin mechanism. For example, the present invention can be applied to a type of coin mechanism in which a coin identification device only determines whether or not a coin put in is a particular kind of coin and a coin distribution device selectively sets the course of transport of the coin between a reception path and a discharge path. This type of coin mechanism is incapable of receiving coins with respect to kinds of coin and, therefore, ordinarily has no coin discharge device for making change.

1. A coin mechanism comprising:
a coin identification device for determining whether or not a coin put is genuine and for identifying the kind of the coin;
a coin distribution device for selectively setting the course of transport of the coin between an acceptance path and a discharge path according to a result of identification by the coin identification device; and
a control device for controlling the coin identification device and the coin distribution device,
wherein the control device includes a main control section for controlling the coin identification device and the coin distribution device in a normal mode, and a management processing section for performing processing for management in a management mode, and
wherein the management processing section performs particular processing according to the kind of coin identified by coin identification device.

2. The coin mechanism according to claim 1, wherein the control device further includes storage section for storing setting information necessary for control processing, and the management processing section changes a value in the setting information stored in the storage section according to the kind of coin identified by the coin identification device.

3. The coin mechanism according to claim 1, further comprising mode selection means for selecting between the normal mode and the management mode,
wherein the control device selects, by the mode selection means, between processing by the main control section and processing by the management processing section.

4. The coin mechanism according to claim 1, further comprising a setting input switch, wherein the management processing section performs particular processing according to an input value from the switch and the kind of coin identified by the coin identification device.

5. The coin mechanism according to claim 4, further comprising a coin holder in which coins are held with respect to kinds of coin,
wherein the coin distribution device selectively sets the course of transport of the coin to a path to the coin holder according to the kind of the coin identified by the coin identification device, and
wherein the management processing section makes a setting on the basis of the input value from the switch and the kind of the coin identified by the coin identification device, such that the coin identified by the coin identification device is transported to and held in a portion of the coin holder corresponding to the input value from the switch.

6. The coin mechanism according to claim 1, wherein the management processing section makes a setting on the basis of the kind of the coin identified by the coin identification device, such that a kind of currency on which processing is to be performed by the main control section is the kind of currency including the identified kind of the coin.
